(19) United States
(12) Patent Application Publication
(10) Pub. No.: US 2006/0187664 A1
(43) Pub. Date: Aug. 24, 2006

(54) D-shape cross-section cross arm for elevation of devices on poles

(75) Inventors: Myron K. Gordin, Oskaloosa, IA (US); Timothy J. Boyle, Oskaloosa, IA (US)

Correspondence Address: MCKEE, VOORHEES & SEASE, P.L.C., 801 GRAND AVENUE, SUITE 3200, DES MOINES, IA, 50309-2721, US

(73) Assignee: MUSCO CORPORATION, Oskaloosa, IA (US)

(21) Appl. No.: 11/333,115

(22) Filed: Jan. 17, 2006

Related U.S. Application Data
(60) Provisional application No. 60/644,687, filed on Jan. 18, 2005.
(60) Provisional application No. 60/644,639, filed on Jan. 18, 2005.
(60) Provisional application No. 60/644,536, filed on Jan. 18, 2005.
(60) Provisional application No. 60/644,747, filed on Jan. 18, 2005.
(60) Provisional application No. 60/644,534, filed on Jan. 18, 2005.
(60) Provisional application No. 60/644,720, filed on Jan. 18, 2005.
(60) Provisional application No. 60/644,688, filed on Jan. 18, 2005.
(60) Provisional application No. 60/644,636, filed on Jan. 18, 2005.
(60) Provisional application No. 60/644,517, filed on Jan. 18, 2005.
(60) Provisional application No. 60/644,609, filed on Jan. 18, 2005.
(60) Provisional application No. 60/644,516, filed on Jan. 18, 2005.
(60) Provisional application No. 60/644,546, filed on Jan. 18, 2005.
(60) Provisional application No. 60/644,547, filed on Jan. 18, 2005.
(60) Provisional application No. 60/644,638, filed on Jan. 18, 2005.
(60) Provisional application No. 60/644,537, filed on Jan. 18, 2005.
(60) Provisional application No. 60/644,637, filed on Jan. 18, 2005.
(60) Provisional application No. 60/644,719, filed on Jan. 18, 2005.
(60) Provisional application No. 60/644,784, filed on Jan. 18, 2005.

(51) Int. Cl. F21V 19/00

(52) U.S. Cl. 362/382

(57) ABSTRACT

A cross arm for suspended items or devices from relatively tall poles comprising an elongated tubular member having top, bottom, front, and rear sides along the longitudal axis, an opposite ends, the front side comprising a generally rounded shape.

### CROSS REFERENCE TO RELATED APPLICATIONS

This application is a non-provisional of U.S. Ser. No. 60/644,687 filed Jan. 18, 2005, herein incorporated by reference in its entirety. This application is also a non-provisional of the following provisional U.S. applications, all filed Jan. 18, 2005: U.S. Ser. No. 60/644,639; U.S. Ser. No. 60/644,536; U.S. Ser. No. 60/644,747; U.S. Ser. No. 60/644,534; U.S. Ser. No. 60/644,720; U.S. Ser. No. 60/644,688; U.S. Ser. No. 60/644,636; U.S. Ser. No. 60/644,517; U.S. Ser. No. 60/644,609; U.S. Ser. No. 60/644,516; U.S. Ser. No. 60/644,546; U.S. Ser. No. 60/644,547; U.S. Ser. No. 60/644,638; U.S. Ser. No. 60/644,537; U.S. Ser. No. 60/644,637; U.S. Ser. No. 60/644,719; U.S. Ser. No. 60/644,784; each of which is herein incorporated by reference in its entirety.

### INCORPORATION BY REFERENCE

The contents of the following U.S. Patents are incorporated by reference by their entirety: U.S. Pat. Nos. 4,816,974; 4,947,303; 5,161,883; 5,600,537; 5,816,691; 5,856,721; 6,036,338.

### I. BACKGROUND OF THE INVENTION

A. Field of the Invention

The present invention relates to cross-arms that are suspended on relatively tall poles to, in turn, elevate and suspend items or devices. One example of items or devices is lighting fixtures that produce high intensity, controlled, and concentrated light beams for use at relatively distant targets. One primary example is illumination of a sports field.

B. Problems in the Art

Illumination of sports fields is generally called sports lighting. FIGS. 1A-1G illustrate one such sports lighting configuration. Football field 5 of FIG. 1A is illuminated by a set of arrays 1 of light fixtures 2 elevated on poles 6 (see FIG. 1A).

The most conventional form of sports lighting fixture 2 is a several feet in diameter bowl-shaped aluminum reflector with a transparent glass lens 3 suspended from a cross arm 7 fixed to a pole 6 by an adjustable knuckle 4 (see FIG. 1B). Each light fixture 2 has some adjustability both around vertical and horizontal axes. Each fixture 2 can therefore be uniquely aimed relative to the target area or field 5 by adjustment of knuckle 4 relative cross arm 7.

This general configuration of sports lighting fixtures 2 has remained relatively constant over many years because it is a relatively economical and durable design. It represents a reasonable compromise between the desire to economically control high intensity light to a distant target while at the same time minimizing wind load, which is a particularly significant issue when fixtures are elevated out-of-doors to sometimes well over 100 feet in the air. A much larger reflector could control light better. However, the wind load would be impractical. A significant amount of the cost of sports lighting systems involves how the lights are elevated. The more wind load, the more robust and thus more expensive, the poles must be. Also, conventional aluminum bowl-shaped reflectors are formed by a spinning process. Different light beam shapes are needed for different fixtures 2 on poles 6 for different lighting applications. The spinning process for creating aluminum bowl-shaped reflectors is relatively efficient and economical, even for a variety of reflector shapes and light controlling effects. The resistance of aluminum to corrosion is highly beneficial, particularly for outdoors lighting.

Therefore, competing interests and issues provide challenges to sports lighting designers.

### II. SUMMARY OF THE INVENTION

The present invention relates to a cross-arm for elevating items or devices to substantial heights, for example, on relatively tall poles. It comprises a cross-arm having similar structural attributes to state of the art rectangular-in-cross-section elongated metal tubular cross arms, except its leading face has a curved or rounded shape. Optionally, its front edge to back edge width is greater than conventional cross-arms.

A. Objects, Features, or Advantages, of the Invention

It is therefore a principal object, feature, or advantage of the present invention to present a high intensity lighting fixture, its method of use, and its incorporation into a lighting system, which improves over or solves certain problems and deficiencies in the art.

Other objects, features, or advantages of the present invention include such a fixture, method, or system which can accomplish one or more of the following:
a) is robust, strong, and durable for most applications;
b) can reduce wind drag or effective projected area (EPA) of the combination that is suspended from the pole;
c) can be fabricated relatively economically.

These and other objects, features, advantages and aspects of the present invention will become more apparent with reference to the accompanying specification and claims.

### III. BRIEF DESCRIPTION OF THE DRAWINGS

A. General Sports Lighting Systems

FIG. 1A and its sub-parts B-F illustrate generally a sports lighting system, and conventional components for a sports lighting system.

B. General Parts of Fixture 10

FIG. 2 is a diagrammatic, partial exploded view of a light fixture 10 that could be used with an exemplary embodiment of the present invention. It is to be understood the invention could support almost any type of light fixture, and could support or elevate things other than lights fixtures.

C. D-Shape Cross Arm

FIGS. 3A-W illustrates a cross-arm to which one or more fixtures can be mounted. The cross arm has a “D” shape profile or cross-section, which improves EPA.

FIGS. 4A-K are various views of embodiments of the D-shaped cross arm according to the invention, installed on a pole fitter or top and with mounting knuckles for light fixtures attached.

### IV. DETAILED DESCRIPTION OF EXEMPLARY EMBODIMENTS

A. Overview

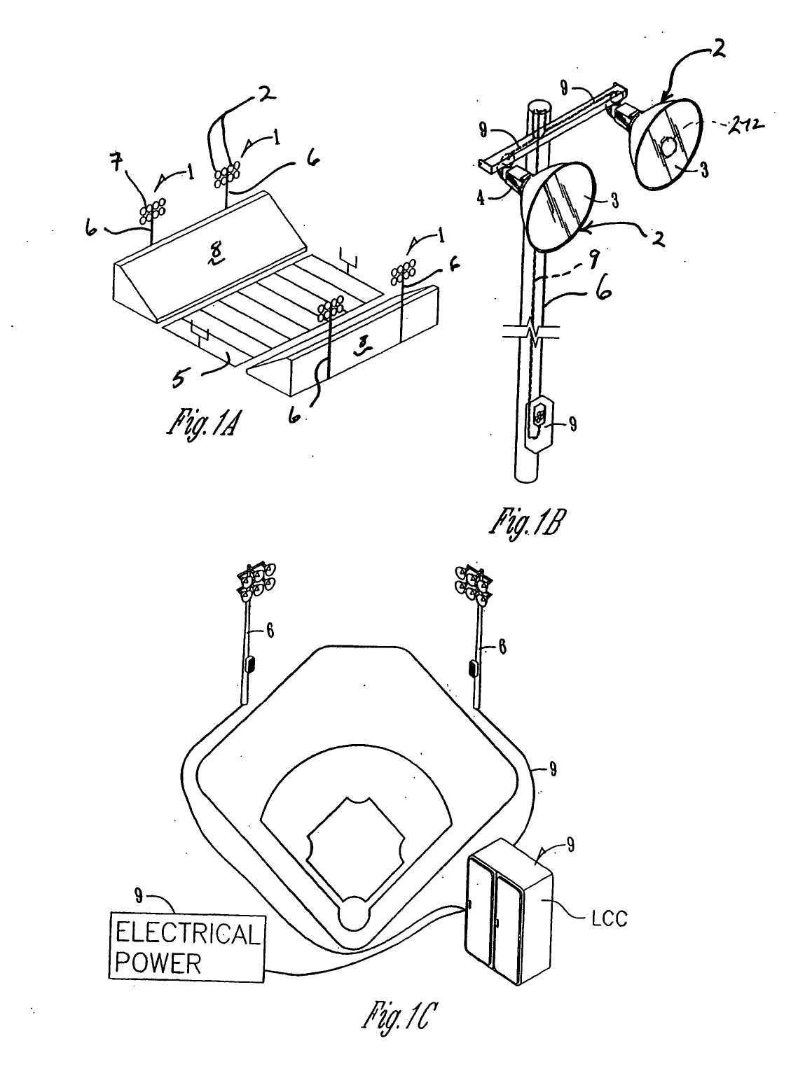

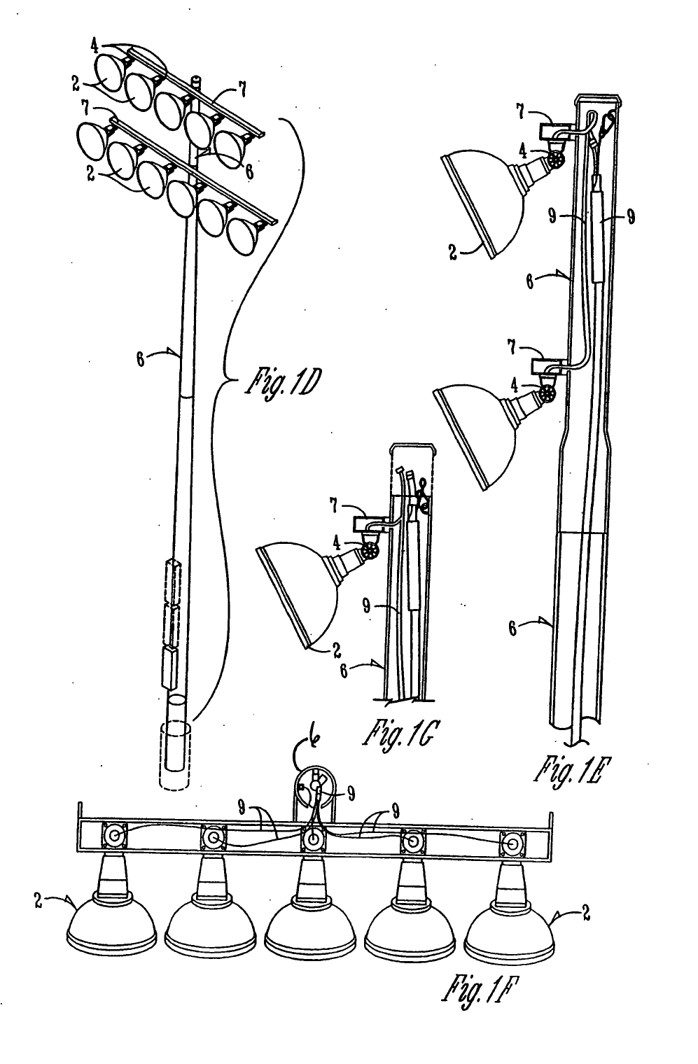

An embodiment of a lighting system will be described in the context of sports lighting, sports lighting fixtures, and sports lighting systems for the illumination of athletic fields such as shown in FIGS. 1A and 1C. The lighting system must light the field and a volume of space above the field (collectively sometimes called the target area or target space), according to predetermined lighting level and uniformity specifications. The embodiment relates to fixtures that utilize high intensity discharge (HID) lamps, presently normally 1,000 watts or higher, of the metal halide type. Such installations generally have several arrays of fixtures usually elevated on two or more relatively tall poles (35 feet to 100 or more feet).

In this context, the athletic field is therefore the target area or space. There could be more than one target area per sports facility. It is to be understood, however, that the present invention has applicability to other applications utilizing these or other HID lamps, and is not limited just to these types of HID lamps or to sports lighting.

B. Exemplary Apparatus
1. D-Shape Cross Arm

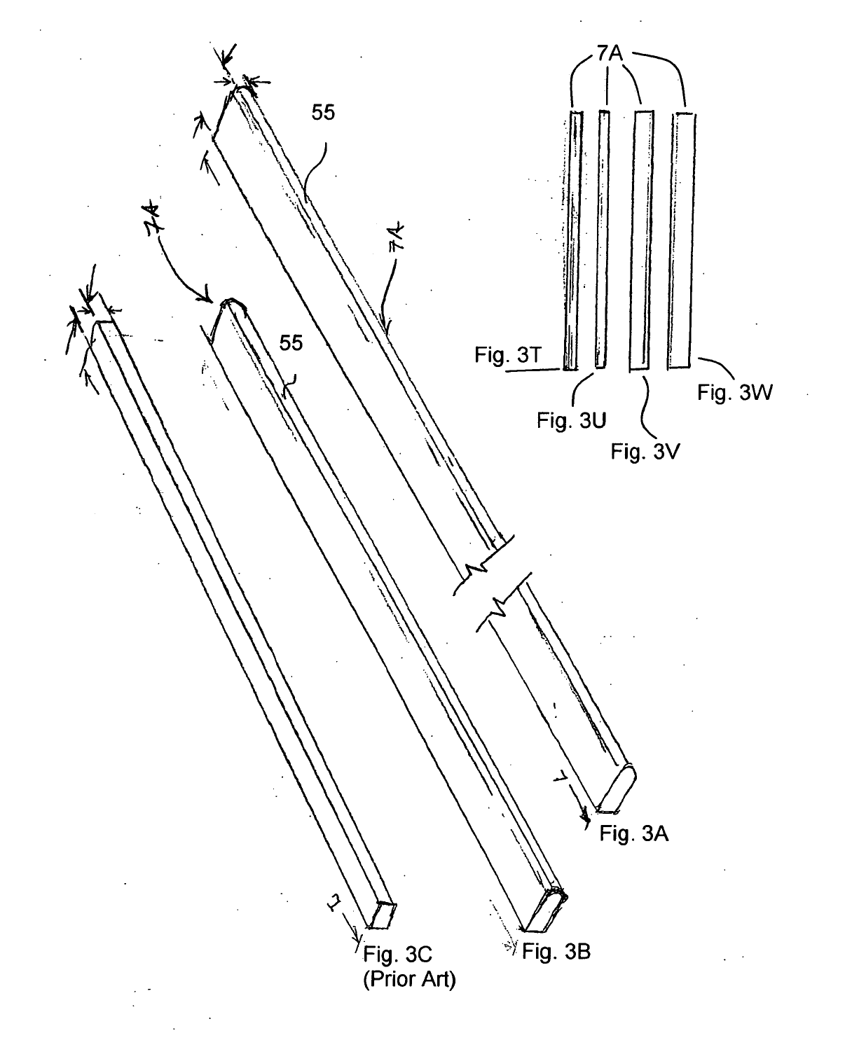

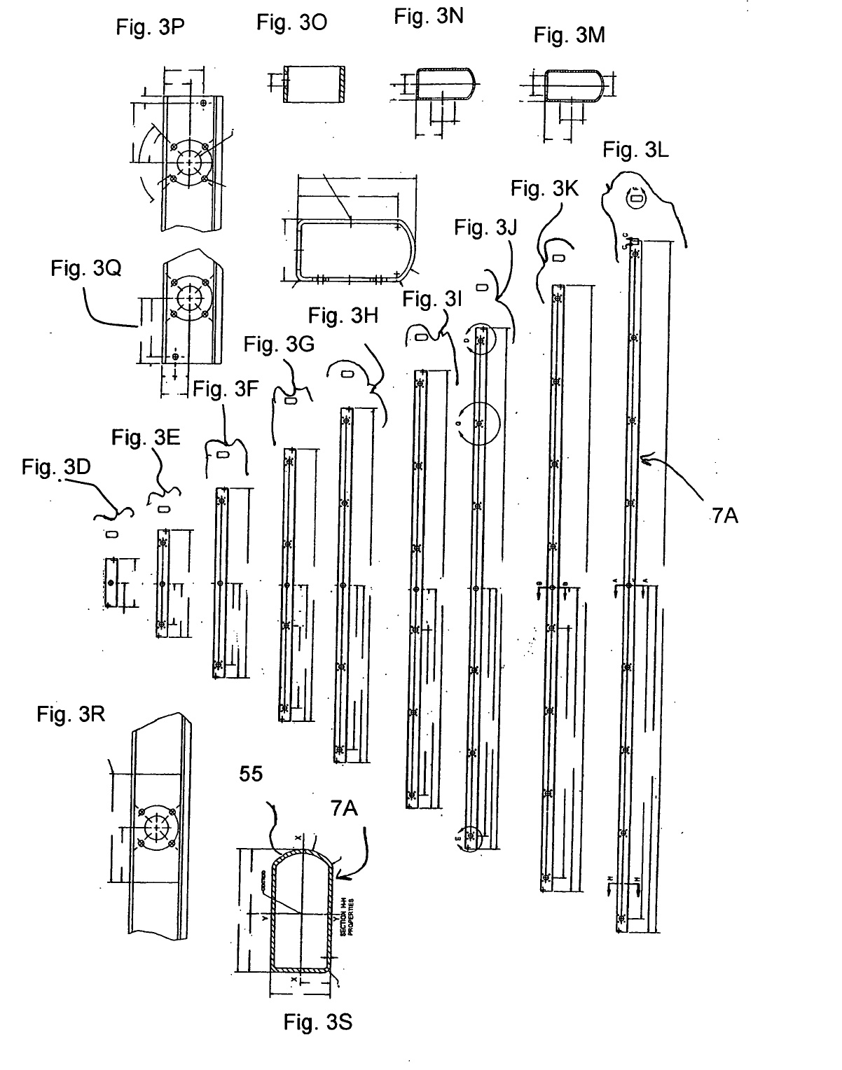

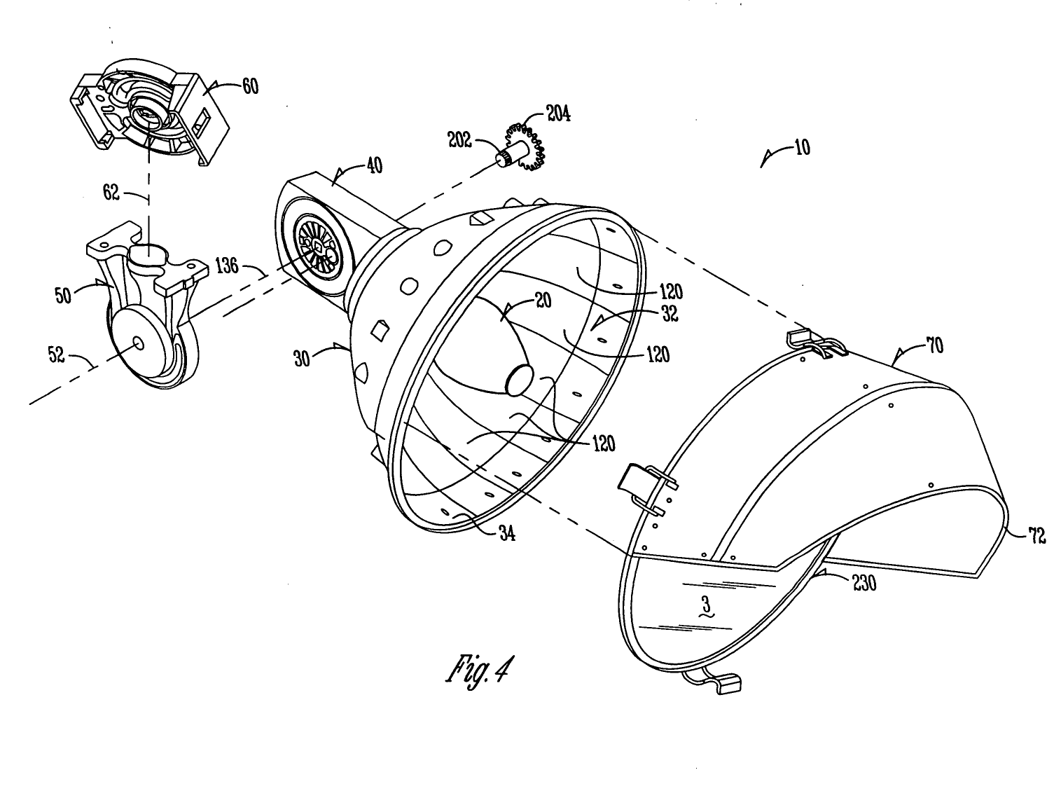

FIGS. 3A-W illustrate an optional cross arm 7A that could be used with fixtures 10. As shown in FIGS. 3A, B and S, the cross arm has a generally rectangular in cross section shape except one vertical side 55 is generally rounded or curved. It has a radius of curvature. Additionally, the width of cross arm 7A (from front edge 55 to the opposite back edge) is increased (e.g. 30% to 40%) over conventional square or rectangular tubular cross arms (illustrated generally by comparing prior art cross arm at FIG. 3C with all sides square or flat and shorter width W).

It has been found that the highest wind load is straight on to this front face of the cross arm because the fixtures face forward. This shape can reduce wind load on the cross arm, and thus on the pole. This can contribute to decreased EPA for the entire array. It therefore can sometimes allow for a cheaper pole (e.g. thinner metal wall or smaller diameter).

It can also be efficiently manufactured from readily available round tubular stock. Its flat sides can be rolled, leaving the curvature at side 55. Thus it is not an expensive addition. It also has about the same strength as rectangle tubing.

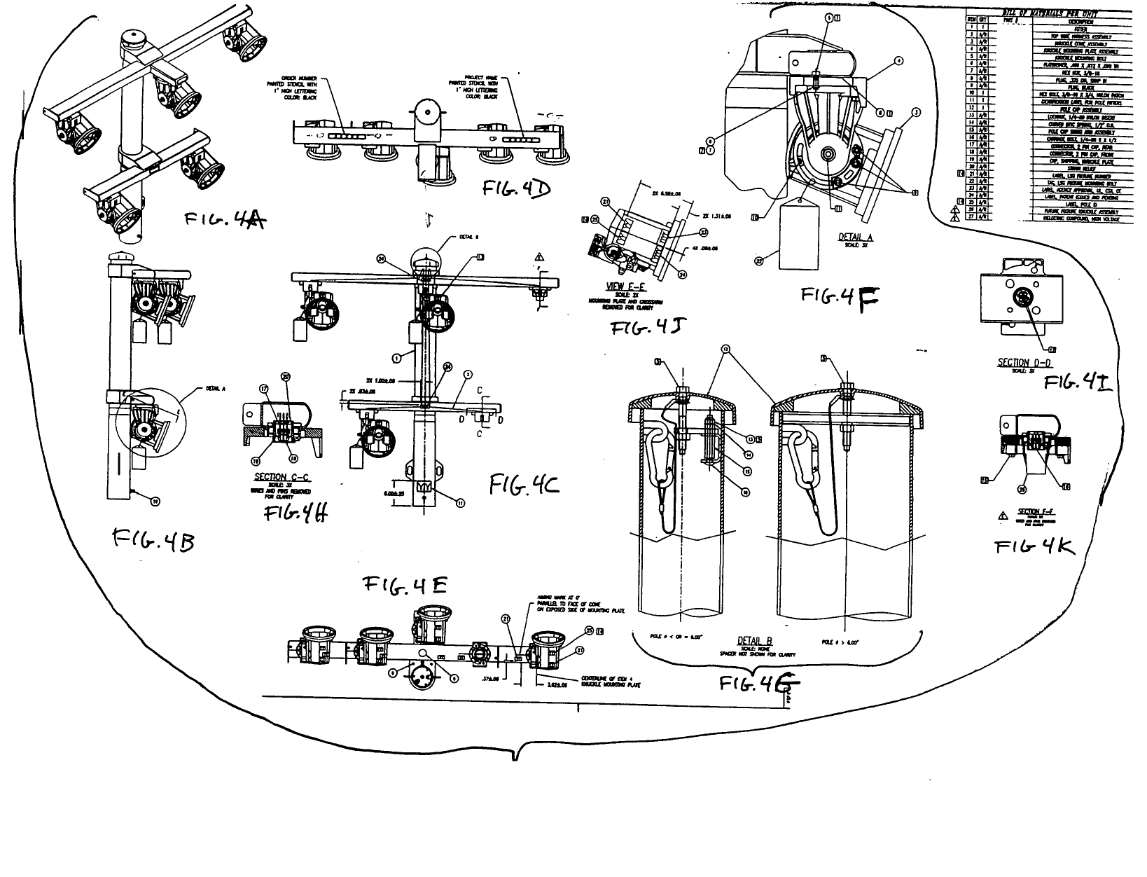

Note how it can be made to different conventional lengths (e.g. FIGS. 3D-L) and have formed mounting openings along the bottom side for a plurality of fixtures 10. Each fixture 10 has a mounting bracket 60 that is bolted to the mounting openings on cross-arm 7A through aligned openings in bracket 60. In this embodiment cross arm 7A is approximately 2 inches high (H) and 3.875 inches wide (W). Length L varies between approximately 1 and ⅓ feet (FIG. 3D) to 18.7 feet (FIG. 3L). The radius of curvature and wall thickness of this embodiment is shown, proportionally, in the drawings.
2. Options and Alternatives

It can be appreciated that the present invention can take different forms and embodiments. Variations obvious to those skilled in the art will be included with the invention.

What is claimed is:

1. A cross arm for suspending items or devices from relatively tall poles comprising:
a. an elongated tubular member having top, bottom, front, and rear sides along a longitudinal axis, and opposite ends;
b. the front side comprises a generally rounded shape.

2. The cross arm of claim 1 wherein the top and bottom sides are generally parallel and equal in width.

3. The cross arm of claim 2 wherein the rear side is generally planar.

4. The cross arm of claim 1 wherein the generally rounded shape convex with a radius of curvature perpendicular the longitudinal axis of the member.

5. The cross arm of claim 1 wherein one elongated side comprises a D-shape-cross section or profile.

6. The cross arm of claim 1 further comprising at least one mounting structure along the tubular member adapted for mounting of a lighting fixture.

7. The cross arm of claim 6 wherein the mounting structure comprises an opening.

8. The cross arm of claim 6 further comprising a plurality of mounting structures along the tubular member.

9. The cross arm of claim 1 in combination with one or more lighting fixtures.

10. The cross arm of claim 9 in combination with a pole.

11. The cross arm of claim. 1 further comprising closed opposite ends of the tubular member.
